(19) United States
(12) Patent Application Publication
(10) Pub. No.: US 2020/0373635 A1
(43) Pub. Date: Nov. 26, 2020

(54) METHOD FOR INTRODUCING A HEAT-CONDUCTING MEDIUM BETWEEN A BATTERY MODULE AND A COOLING BASE, INJECTION SYSTEM, AND BATTERY MODULE

(71) Applicant: AUDI AG, Ingolstadt (DE)

(72) Inventors: Marc GORMANNS, Erlenbach (DE); Tobias BENKER, Heilbronn (DE); MichaeI FRAUENHOFER, Aichach (DE); Pedro DE SOUSA SCHMIECH, Leingarten (DE); Michael SCHUESSLER, Neckarsulm (DE)

(73) Assignee: AUDI AG, Ingolstadt (DE)

(21) Appl. No.: 16/878,987

(22) Filed: May 20, 2020

(30) Foreign Application Priority Data
May 20, 2019 (DE) 102019207357.3

(51) Int. Cl. H01M 10/653; H01M 10/613; H01M 10/655

(52) U.S. Cl. CPC H01M 10/653; H01M 10/655; H01M 10/613

(57) ABSTRACT

The disclosure relates to a method for introducing a heat-conducting medium between a battery module and a cooling base, wherein the battery module is positioned in relation to the cooling base such that a lower side of the battery module faces toward the cooling base and an upper side of the battery module faces away from the cooling base.

### FIELD

The invention relates to a method for introducing a heat-conducting medium between a battery module and a cooling base, wherein the battery module is positioned in relation to the cooling base such that a lower side of the battery module faces toward the cooling base and an upper side of the battery module faces away from the cooling base. The invention also includes an injection system for introducing a heat-conducting medium between a battery module and a cooling base, and also a battery module.

### BACKGROUND

High-voltage batteries for motor vehicles known from the prior art typically comprise multiple battery modules, which can in turn comprise multiple individual battery cells. Such battery cells are typically juxtaposed in the form of a cell stack here and accommodated in a module housing. The battery modules thus formed are inserted into an overall battery housing to provide the high-voltage battery. Furthermore, such battery modules typically also have to be cooled. For this purpose, for example, a corresponding cooling unit can be integrally formed with the base of the overall battery housing or can be arranged on the lower side on the housing base. In both cases, a cooling base for the high-voltage battery is thus provided. However, because of tolerances, greater or lesser tolerances occur between the respective lower sides of the battery modules and such a cooling base upon the arrangement of the battery modules in this overall battery module housing. To be able to dissipate the heat arising in the high-voltage batteries, above all during fast charging and during power retrieval, in electric vehicles, a heat-conducting medium, for example, a heat-conducting paste, also called gap filler, is typically used between the battery modules and the cooling base. In this case, such a gap filler is firstly applied in beads to the cooling base and then slowly pressed into the surface by placing and lowering the battery module.

This type of introduction of such a gap filler or of a heat-conducting medium in general between the battery module and the cooling base has numerous disadvantages in this case. Among other things, very high forces are to be applied to the battery module for this purpose to be able to distribute the gap filler sufficiently uniformly. At the same time, however, such forces cannot result in damage to the battery module, which in turn results in a costly robust design of the battery modules. Moreover, due to the limited contact pressure, only relatively large gap heights may be provided between the battery module and the cooling base in this method, which opposes efficient heat dissipation, since the gap filler material does conduct heat better than air, but worse than metals. Moreover, large gap heights moreover cause an increase of costs and weight of the high-voltage battery, since more gap filler compound is required.

To be able to construct the future high-voltage batteries of the electric vehicles in a cost-effective and resource-efficient manner, it is moreover internal prior art to refine a method by means of which such a heat-conducting medium such as the gap filler may be injected in a targeted manner between the battery module and the cooling base. According to such a method, firstly the battery module is placed in the empty battery compartment, i.e., the overall battery housing, and screwed in place. The heat-conducting medium is then injected into the tolerance-related and remaining gap between the battery module and the cooling base. On the one hand, the heat-conducting medium may be injected in this case from below through a hole in the cooling base, and also from above in the region of the battery module.

In the second variant, which is also the subject matter of the considerations in the scope of the present invention, an injection head for injecting the heat-conducting medium is placed from above onto a tube integrated into the battery module, through which the heat-conducting medium is injected and which guides the injection stream downward, where the heat-conducting medium is then pressed in between the module base and the cooling base. However, even with this type of introduction of a heat-conducting medium, problems presently still result. On the one hand, such a heat-conducting medium, such as the gap filler, is typically composed of multiple components, which are only mixed before the application, since these components begin to react upon mixing and then become solid after some time. To thus introduce the heat-conducting medium into the described tube, static mixers are used, which mix the respective components as they pass through. The mixed components are then injected via the mixer directly into the tube. Since the components mixed by the mixer harden in the course of time, the mixer thus also has to be replaced now and then. To keep the costs for this purpose low, the mixer is typically provided as a cost-effective plastic part. A mixer thus produced in a cost-effective manner typically cannot withstand the pressures acting in the mixer, however, in particular the pressures perpendicular to the injection direction, during the mixing and filling of the components into the tube of the battery housing. Therefore, such a mixer is typically also supported by an additional support tube, which accordingly reinforces the side walls of the mixer. Alternatively, the mixer could also be formed having thicker and more stable side walls, which in turn makes it more complex and costly. It would accordingly be desirable to also be able to also simplify this method even further and make it more efficient.

### SUMMARY

The object of the present invention is therefore to provide a method for introducing a heat-conducting medium between a battery module and a cooling base, and also an injection system and a battery module, which enable the simplest possible, gentle, and cost-effective injection of a heat-conducting medium between the battery module and the cooling base.

In a method according to the invention for introducing a heat-conducting medium between a battery module and a cooling base, the battery module is positioned in relation to the cooling base in such a way that a lower side of the battery module faces toward the cooling base and an upper side of the battery module faces away from the cooling base. Furthermore, a static mixer is at least partially inserted into a through opening extending from the upper side to the lower side of the battery module and after the at least partial insertion of the static mixer, multiple components to be mixed to provide the heat-conducting medium are filled into a filling opening of the static mixture at a defined filling pressure, so that the filled components pass through the static mixer and leave the static mixer at the lower side of the battery module through an outlet opening of the static mixer as components mixed by the static mixer to form the heat-conducting medium and are pressed at least partially between the battery module and the cooling base.

In particular, the components, i.e., the mixed components, because of the filling pressure in this case, using which the components are pressed into the filling region or the filling opening of the static mixer, are pressed between the battery module and the cooling base.

The invention has the significant advantage in this case that due to the introduction of the static mixer into the passage opening, which can be provided by the above-described tube in the battery module, the static mixer can be supported by the side wall of this passage opening. Therefore, the provision of an additional support tube for the static mixer is unnecessary, and nonetheless the static mixer can be formed particularly cost-effectively, for example, from plastic having a thin side wall, for example, as a simple plastic tube having integrated mixing coil. Numerous further advantages also result therefrom. The mixed material can flow directly into the cavity, i.e., into the gap between the battery module and the cooling base, and does not have to overcome an additional route first, namely the typical 150 mm flow path in the gate tube. Since the static mixer can thus be inserted directly into this gate tube, the components which have passed through the mixer have thus already also passed through this gate tube at the point in time of the exit from the static mixer. This in turn has a positive effect on the pressure level during the injection, since the flow path of the components or the heat-conducting medium can be reduced as a whole, whereby in particular the pressure in the region between the battery module and the cooling base may be set significantly more precisely, which is particularly relevant, since a certain maximum pressure, for example, 4 bar, cannot be exceeded in order to avoid damage to the battery module, on the other hand, the fastest possible distribution of the heat-conducting medium in the gap is also enabled by the highest possible pressure, and at the same time particularly small gap heights of, for example, at most 1 to 2 mm. In addition, the invention enables the static mixer to plunge deep into the passage opening, whereby the passage opening itself does not have to be filled with the typically relatively costly and heavy gap filler material or in general with the heat-conducting medium. Thus, if the static mixer is moved back out of the passage opening after ending the injection procedure, it thus largely remains unfilled, which provides significant cost and weight advantages. In addition, simplified “hole finding” when approaching the gate point is provided by this method, namely the top opening of the through opening, by means of the static mixer, since it is significantly more flexible due to the support tube, which is no longer required and is thus absent, in order to compensate for position tolerances. In contrast, in the case of the additional and previously required use of a rigid support tube, a very high precision is also required when approaching these gate points. The mixer replacement process is also simplified by the invention, since the support tube, as is previously typical, does not always have to be removed and then installed on the new replaced static mixer to replace the static mixer.

Therefore, numerous advantages may be achieved by the invention, by which the introduction of a heat-conducting medium between a battery module and a cooling base is made significantly easier, more efficient, more time-saving, more cost-effective, and more material-saving and moreover a significantly lower-weight design of a battery, in particular a high-voltage battery for a motor vehicle, is permitted, having significantly more efficient cooling, since particularly small gap heights can moreover also be provided between a battery module and the cooling base by the method according to the invention, so that in this way the heat dissipation from the battery module to the cooling base may also be made particularly efficient.

The static mixer is preferably manufactured from a plastic in this case. This advantageously permits a particularly cost-effective provision of the static mixer. Furthermore, this static mixer can comprise a mixing coil, which is arranged in a cylindrical plastic tube of the static mixer, and by which the components filled into the filling opening are mixed as they pass through the static mixer. The mixing coil can be shaped as a spiral in this case, for example, in particular also as a single spiral, double spiral, or multiple spiral, for example, having openings in the relevant spirals.

The battery module can comprise multiple individual battery cells, for example, lithium-ion cells, which are provided as a cell pack and are arranged, for example, in a module housing. To provide a high-voltage battery for a motor vehicle, multiple such battery modules can be arranged in an overall battery housing, wherein a base of this overall battery housing is provided by the cooling base. In this case, the cooling base can be provided by a base of the battery module and a cooling unit arranged on the bottom on this base, for example, a cooling plate having optional cooling ducts through which a coolant can flow, or the base of the battery module can itself be provided by such a cooling unit, i.e., a cooling plate having optional cooling ducts through which a coolant can flow.

The heat-conducting medium can represent a heat-conducting paste described at the outset, in particular the so-called gap filler. To provide this mixed heat-conducting medium, for example, only two components different from one another can be mixed with one another by passing through the static mixer, or also more than two components, for example, three components, depending on the design of the heat-conducting medium.

Furthermore, it is particularly advantageous if the static mixer is formed having a geometry corresponding to the passage opening in such a way that after the at least partial insertion of the static mixer into the passage opening, an outer wall of the static mixer presses directly against an inner wall of the passage opening, at least when the components to be mixed are flowing through it. This has the significant advantage that the static mixer is thus laterally supported by the inner wall of the passage opening during the introduction of the heat-conducting medium between the battery module and the cooling base. This enables a particularly simple and cost-effective design of the static mixer.

The static mixer can have, for example, a circular cross section, i.e., it can thus be formed having a cylindrical outer wall, as can the corresponding passage opening. In this case, the diameter of the static mixer, i.e., the maximum external diameter of its outer wall, can be equal to or at least slightly smaller than the internal diameter of the passage opening. This enables easy insertion of the static mixer into this passage opening, in particular if the diameter of the static mixer is somewhat smaller than the internal diameter of the passage opening, and simultaneously a support function can be provided by the passage opening.

In a further advantageous design of the invention, the static mixer is inserted into the passage opening in such a way that the outlet opening providing a lower end of the static mixer is inserted on top into the passage opening and guided through the passage opening at least to the lower side of the battery module, in particular wherein the passage opening comprises a circumferential chamfer or a circumferential collar or a circumferential cone on top, in particular comprises a circumferential conical collar, and has a tapering cross section in the profile toward the lower side, so that the static mixer can only be guided through the passage opening up to an end position defined by the tapering cross section. The outlet opening of the static mixer can thus terminate, for example, with the lower side of the battery module. The mixed material exiting from this outlet opening, in particular the heat-conducting medium, thus enters directly into the gap between the lower side of the battery module and the cooling base. The path from this outlet opening to the gap to be filled can thus advantageously be minimized, which is accompanied by the above-mentioned advantages. Moreover, wetting of the interior of the passage opening by the mixed heat-conducting medium can advantageously also be minimized or even completely avoided in this way. The amount of heat-conducting medium which is wasted and/or unused due to the curing in the passage opening can thus be reduced to a minimum. To facilitate the insertion, a circumferential chamfer or a cone could be provided on top on the opening, on which then the static mixer slides down and goes into the hole. In order that the static mixer is not located excessively low down, a cross-sectional reduction in size of the passage opening would also be a further advantageous design of the invention. The cross-sectional reduction in size of the passage opening can be provided, for example, in the form of a step, by which the internal diameter of the passage opening is reduced by 2 mm and on which the static mixer then rests at the bottom The significant advantage in this case is that the static mixer thus can never be excessively low.

Accordingly, it is also advantageous if, as is provided according to a further advantageous design of the invention, the static mixer is inserted into the passage opening in such a way that an upper end of the static mixer, at which the filling opening of the static mixer is located, is at least not inserted completely into the passage opening. In other words, this upper end of the static mixer, which is opposite to the above-mentioned lower end of the static mixer, can either terminate directly with the upper side of the battery module or can even protrude somewhat beyond it. This enables particularly simple filling of the components to be mixed and, in addition, in this way an inner wall of the passage opening is prevented from being wetted by and/or coming into contact with the components of the heat-conducting medium on the upper side, for example, so that due to this type of the insertion of the static mixer, the passage opening can be kept substantially free of any residues of the components of the heat-conducting medium which are mixed or are to be mixed.

The upper end of the static mixer is preferably coupled in this case to an injection device, which fills the components to be mixed into the static mixer when the static mixer is inserted as intended into the passage opening.

Due to these advantageous designs of the invention, the static mixer can thus be inserted into the through opening in such a way that the components of the heat-conducting medium to be mixed, which are mixed as they pass through, do not come into contact with the inner wall of the passage opening, at least not during the filling procedure. A certain residue can possibly remain at the bottom in the passage opening upon the removal of the static mixer from the passage opening. The quantity of unused gap filler material can thus be reduced to a minimum, whereby weight and cost advantages in turn result.

The static mixer can thus advantageously be removed from the passage opening after the introduction of the heat-conducting medium between the at least one battery module and the cooling base. The cavity provided by the passage opening therefore advantageously remains largely unclosed, from which the described weight and cost advantages in turn result. In addition, this permits a particularly efficient utilization of the static mixer, which can then be inserted into the next passage opening of the next battery module subsequently thereto, for example, to also inject the heat-conducting medium therein.

It therefore represents a further advantageous design of the invention if the static mixer, after the removal from the passage opening, is inserted into a second passage opening of a second battery module to introduce the heat-conducting medium between the second battery module and the cooling base. The heat-conducting medium can thus advantageously be introduced gradually between the respective battery modules of a high-voltage battery and the cooling base provided by the overall battery housing in a particularly simple and efficient manner. However, it would also be conceivable that the respective passage openings provided by respective battery modules are done simultaneously by various static mixers, which are inserted into the relevant passage openings and then simultaneously mix and inject the heat-conducting medium. However, it is significantly more efficient and cost-effective to use the same static mixer at least for multiple battery modules, for example, until it has to be replaced, since thus the heat-conducting medium may be applied between many battery modules and the cooling base using only one single static mixer.

Furthermore, it is provided that the battery module is fastened on a battery housing providing the cooling base, namely the above-mentioned overall battery housing, before the heat-conducting medium is introduced between the battery module and the cooling base. A later offset of the battery module due to the injection pressure can thus particularly advantageously be prevented. This enables minimum gap heights between the battery module and the cooling base and a particularly gentle injection of the heat-conducting medium at the same time.

Furthermore, the invention also relates to an injection system for introducing a heat-conducting medium between a battery module and a cooling base, wherein the injection system comprises the battery module, which is positionable in relation to the cooling base in such a way that a lower side of the battery module faces toward the cooling base and an upper side of the battery module faces away from the cooling base. Furthermore, in this case a passage opening extending from the upper side to the lower side of the battery module is arranged in the battery module and the injection system furthermore comprises a static mixer, which is at least partially insertable into the passage opening, and which comprises a filling opening, into which multiple components to be mixed to provide the heat-conducting medium can be filled at a defined filling pressure after its at least partial insertion into the passage opening, so that the filled components pass through the static mixer and leave the static mixer at the lower side of the battery module through an outlet opening of the static mixer as components mixed by the static mixer to form the heat-conducting medium and can be pressed at least partially between the battery module and the cooling base.

The advantages described for the method according to the invention and its embodiments apply in the same way to the injection system according to the invention.

The invention also includes refinements of the injection system according to the invention, as they have already been described in conjunction with the refinements of the method according to the invention. For this reason, the corresponding refinements of the injection system according to the invention are not described once again here.

Furthermore, the invention also relates to a battery module for an injection system according to the invention or one of its designs or for use in an injection system according to the invention or in one of its designs. The battery module comprises the passage opening here, into which the static mixer of the injection system is at least partially insertable. As described above, this passage opening is preferably formed corresponding to the geometry of the static mixer, so that this static mixer is not only insertable into the passage opening, but rather also can be laterally supported by the inner wall of this passage opening during the injection. Accordingly, the advantages mentioned for the method according to the invention and its designs also apply in the same way here to the battery module according to the invention.

In addition, it is advantageous if the battery module comprises a module housing and a cell stack, which is accommodated in the module housing and comprises multiple individual battery cells, for example, lithium-ion cells, wherein the module housing comprises at least one first side wall, which delimits the cell stack in its longitudinal extension direction, and wherein the passage opening into which the static mixer is at least partially insertable is arranged in the at least one first side wall. In other words, the passage opening is provided in a module housing of the battery module, in particular in at least one of the two pressure plates or end plates delimiting the cell stack in its longitudinal extension direction, which can additionally be connected by second side walls extending in the longitudinal extension direction of the cell stack. The cell stack can thus be clamped between these two first side walls provided, for example, by the end plates. The first side walls, since they are used for clamping the cell stack, can accordingly be formed as pressure plates, via which a certain pressure can be applied to the opposite ends of the cell stack facing one another by the clamping by means of the second side walls extending in the longitudinal extension direction. This counteracts the expansion of the battery cells, the so-called swelling, and thus extends the service life of the battery cells. Multiple functions can thus advantageously be integrated into such end plates.

It is moreover particularly advantageous in this case if the passage opening is arranged, with respect to a width extending perpendicular to the longitudinal extension direction and perpendicular to the extension direction of the passage opening, of the at least one first side wall in an edge region of the at least one first side wall. In other words, the passage opening extends closer to the edge of this width of the first side wall than to the center of this width. This is particularly advantageous because further components can thus also be integrated into such a first side wall, which moreover also functions as an end plate and/or pressure plate, for example, also electronic components, control units, for example, module control units, or also handle elements, on which such a battery module may be easily grasped, moved, and positioned, in particular by means of a so-called handling device, or other various components. Due to the positioning of this passage opening in the edge region, this passage opening does not have an interfering effect on other further components integrated into the at least one first side wall and the function thereof. In particular, the integration of such a through opening in the side region of the at least one first side wall does not require a structural change of this first side wall as such, or of its other integrated components. Such a side wall, and also the module housing and the battery module in general, may thus in turn be provided particularly cost-effectively.

A high-voltage battery for a motor vehicle having such a battery module, in particular also having multiple such battery modules, and also a motor vehicle having such a high-voltage battery are to be considered to be included by the invention.

The motor vehicle according to the invention is preferably designed as an automobile, in particular as a passenger automobile or truck, or as a minibus or motorcycle.

The invention also comprises combinations of the features of the described embodiments.

### BRIEF DESCRIPTION OF THE DRAWINGS

Exemplary embodiments of the invention are described hereafter. In the figures:

FIG. 1 shows a schematic illustration of an injection system for introducing a heat-conducting medium between a battery module and a cooling base by means of a static mixer in the state not inserted into a passage opening provided by the battery module according to a first exemplary embodiment of the invention; and

FIG. 2 shows a schematic illustration of the injection system from FIG. 1, in which the static mixer is now inserted into the passage opening provided by the battery module.

### DETAILED DESCRIPTION

The exemplary embodiments explained hereafter are preferred embodiments of the invention. In the exemplary embodiments, the described components of the embodiments each represent individual features of the invention to be considered independently of one another, which each also refine the invention independently of one another. Therefore, the disclosure is also to include combinations of the features of the embodiments other than those illustrated. Furthermore, the described embodiments can also be supplemented by further ones of the above-described features of the invention.

In the figures, identical reference signs each identify functionally-identical elements.

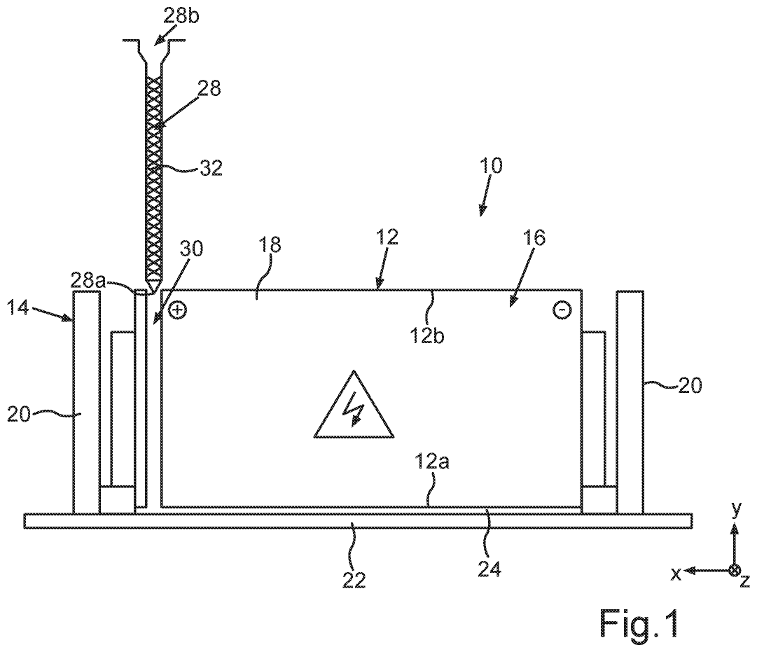

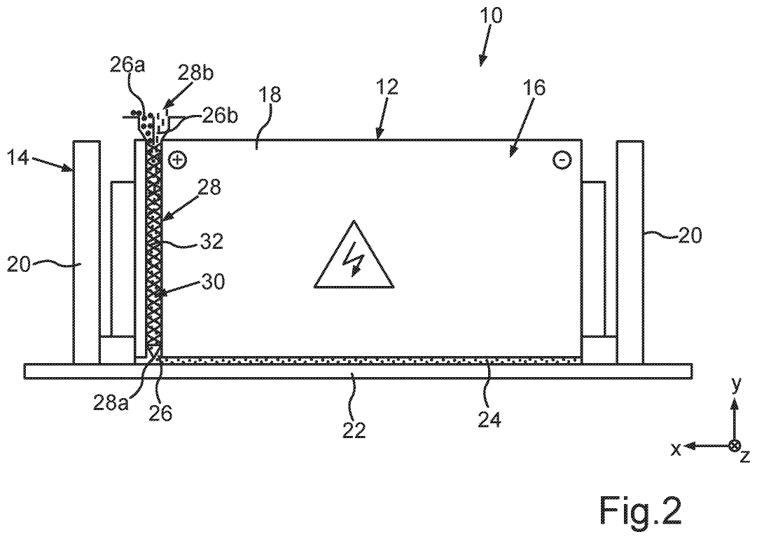

FIG. 1 shows a schematic illustration of an injection system 10 for introducing a heat-conducting medium 26 (cf. FIG. 2) between a battery module 12 and a cooling base 22 by means of a static mixer 28 according to one exemplary embodiment of the invention, wherein in this illustration the static mixer 28 is located outside a passage opening 30 provided by the battery module 12. The battery module 12 can in turn comprise a module housing 16, in which multiple individual battery cells (not shown in greater detail here) can be accommodated in the form of a cell stack extending in a longitudinal extension direction. This longitudinal extension direction corresponds in this case to the z direction of the coordinate system illustrated in FIG. 1. These individual battery cells can be formed in this case as prismatic cells. To form the cell stack, these battery cells are preferably arranged having the largest side with respect to area thereof facing toward one another and adjacent to one another in the longitudinal extension direction z. The module housing 16 can be provided in this case, inter alia, by two end plates 18, of which only one is visible in FIG. 1, which delimit the cell stack in its longitudinal extension direction z, and by two side walls extending in the longitudinal extension direction z, which connect these end plates 18 to one another.

The cooling base 22 is furthermore provided as part of an overall battery housing 14, in which the battery module 12 is accommodated. In particular, multiple such battery modules 12 can be accommodated in such an overall battery housing 14. They then accordingly provide an overall battery, for example, a high-voltage battery for motor vehicle. In addition to the cooling base 22, the overall battery housing 14 can also comprise a frame 20, onto which the battery module 12 is fastened, for example, is screwed on. A gap 24 of greater or lesser size always results due to tolerance in this case between the lower side 12a of the battery module and such a cooling base 22. The lower side 12a of the battery module 12 is opposite to an upper side 12b of the battery module 12 in this case. This lower side 12a and this upper side 12b moreover simultaneously also provide a corresponding lower side 12a and an upper side 12b of the side plate and/or the end plate 18 here. In order to enable the most efficient possible heat dissipation from the battery module 12 to the cooling base 22, this gap 24 is filled using the mentioned heat-conducting medium 26, for example, a heat-conducting paste, a so-called gap filler. Thermally insulating air gaps between the battery module 12 and the cooling base 22 can thus advantageously be avoided. Since such a heat-conducting paste 26 typically nonetheless has a lower heat conductivity than, for example, a metal, it is preferable to keep this gap 24 as small as possible. Moreover, such a heat-conducting paste 26 is relatively costly and heavy, so that it is moreover desirable to keep the required quantity of such a heat-conducting medium 26 as low as possible. The introduction of such a heat-conducting medium 26 into the described gap 24 may now be provided by the invention and its designs in a particularly easy, efficient, cost-effective, and material-saving manner.

For this purpose, the battery module 12, preferably in at least one of its end plates 18, comprises the mentioned passage opening 30, which can be provided as a tube, and is also referred to hereafter as a gate tube or injection tube. The heat-conducting medium, which is particularly suitable for filling the gap 24, is typically composed of multiple separate components 26a, 26b, which, upon contact with one another, react and gradually cure. Therefore, these multiple components 26a, 26b (cf. FIG. 2) should also be mixed with one another only shortly before the introduction of the heat-conducting medium 26 into the gap 24. This is performed by the mentioned static mixer 28. These components 26a, 26b have to be pressed in this case using a corresponding filling pressure through the static mixer 28, so that the heat-conducting medium 26 thus mixed can be pressed below the battery module 12 and into the gap 24 upon exit from the static mixer 28. To be able to form the static mixer 28 as cost-effectively as possible in this case, for example, from plastic having a thin plastic wall, such a static mixer 28 typically has to be laterally supported, since such a cost-effective static mixer 28 otherwise cannot itself withstand these acting pressures. This is advantageously effectuated in that this static mixer 28 is inserted into the mentioned passage opening 30 before the injection of the heat-conducting medium 26, as illustrated in FIG. 2.

FIG. 2 schematically shows the injection system 10 from FIG. 1 here, in which the static mixer 28 is now inserted into the passage opening 30. In this manner, an additional support tube for the static mixer 28 can be omitted. This permits a significantly simpler design of this overall system and of the injection procedure as such, as will be explained in greater detail later. To facilitate the insertion, a circumferential chamfer or a cone could be on top on the opening 30, on which the static mixer 28 then slides down and goes into the hole 30. In order that the static mixer 28 is not located excessively far down, a cross-sectional reduction in size of the passage opening 30 would also be a further advantageous design of the invention. The cross-sectional reduction in size of the passage opening 30 can be provided, for example, in the form of a step, by which the internal diameter of the passage opening 30 is reduced by 2 mm and on which the static mixer 28 then rests at the bottom The significant advantage in this case is that the static mixer 28 thus can never be excessively low. If this static mixer 28, which comprises an integrated mixing coil 32, is thus now inserted into this passage opening 30 of the battery module 12 as shown in FIG. 2, in particular so that an outlet opening 28a of the static mixer is preferably located at the lower side 12a of the battery module 12, the heat-conducting medium 26 is thus filled, using the mention filling pressure, in the form of its separated components 26a, 26b into a filling opening 28b opposite to the outlet opening 28a of the mixer 28. In this case, the upper end of the static mixer 28, which provides this filling opening 28b, can be connected directly to a suitable injection device (not shown in greater detail here), which presses these two or also more than two heat-conducting components 26a, 26b separated from one another into the mixer 28 using the defined filling pressure. These two components 26a, 26b then pass through the mixer 28 from the upper side 12b of the battery module 12 to its lower side 12a and are mixed at the same time by the mixing coil 32 and then exit in a corresponding manner as the mixed heat-conducting medium 26 at the outlet opening 28a and are automatically pressed into the gap 24 between the lower side 12a of the battery module 12 and the cooling base 22. Depending on the size of the battery module 12, multiple such passage openings 30 can also be provided in the battery module and/or is module housing 16, so that the gap 24 below the battery module 12 can be filled completely using such a heat-conducting medium 26. After the gap 24 has been filled in a sufficient manner, the static mixer 28 is removed from the passage opening 30 again. The passage opening 30 thus remains nearly unfilled.

Due to this injection method, in particular in that the mixer 28 can be moved up to the lower side 12a of the battery module 12 to inject the heat-conducting medium 26 by insertion into the passage opening 30 and does not have to be placed on top on this passage opening 30, the mixed material 26 can flow directly into the cavity, i.e., the gap 24, and does not first have to overcome the approximately 150 mm flow path in the gate tube 30. This has a positive effect on the pressure level during the injection and enables significantly more precise setting of the pressure between the battery module 12 and the cooling base 22 during the injection. Due to the deep plunging of the mixer 28 into the gate tube 30, the gate tube 30 is not filled by the costly and heavy gap filler material. This is because if the mixer is moved back out of the gate tube 30 after ending the injection procedure, this tube remains largely unfilled, which is accompanied by cost and weight advantages. Simplified hole finding when approaching the gate points, i.e., the top openings of the gate tube 30, is also enabled, since the mixer is significantly more flexible due to the support tube, which is absent and/or not necessary at this point in time, in particular if the mixer 28 is formed from plastic, and can therefore yield and thus significantly greater position tolerances are permissible between mixer 28 and the gate tube 30 during the insertion of the mixer 28. In addition, the mixer changing process is simplified, since an additional support tube does not always have to be removed and installed on a new mixer 28.

Overall, the examples show how an injection battery module having integrated support tube and/or integrated support tube function can be provided by the invention, in which due to the complete plunging of the static mixer into the gate tube of the battery module, a separate support tube for laterally supporting the mixer during the injection can be omitted, since the function of such a support tube can be assumed by the gate tube itself, which permits significantly more efficient introduction of a heat-conducting paste between the battery module and a cooling base.

1. A method for introducing a heat-conducting medium between a battery module and a cooling base, wherein the battery module is positioned in relation to the cooling base such that a lower side of the battery module faces toward the cooling base and an upper side of the battery module faces away from the cooling base, comprising the following steps:
at least partially inserting a static mixer into a passage opening extending from the upper side to the lower side of the battery module; and
after at least partially inserting the static mixer, filling multiple components to be mixed to provide the heat-conducting medium into a filling opening of the static mixer at a defined filling pressure, so that the filled components pass through the static mixer and leave the static mixer at the lower side of the battery module through an outlet opening of the static mixer as components mixed by the static mixer to form the heat-conducting medium and are pressed at least partially between the battery module and the cooling base.

2. The method as claimed in claim 1, wherein the static mixer is formed having a geometry corresponding to the passage opening in such a way that after at least partially inserting the static mixer into the passage opening, an outer wall of the static mixer presses directly against an inner wall of the passage opening, at least when the components to be mixed are flowing through it.

3. The method as claimed in claim 1, wherein the static mixer is inserted into the passage opening in such a way that the outlet opening providing a lower end of the static mixer is inserted on top into the passage opening and guided through the passage opening at least to the lower side of the battery module, in particular wherein the passage opening comprises a circumferential chamfer or a circumferential collar or a circumferential cone, in particular comprises a circumferential conical collar, and has a tapering cross section in the profile toward the lower side, so that the static mixer can only be guided through the passage opening up to an end position defined by the tapering cross section.

4. The method as claimed in claim 1, wherein the static mixer is inserted into the passage opening in such a way that an upper end of the static mixer, at which the filling opening of the static mixer is located, is at least not inserted completely into the passage opening.

5. The Method as claimed in claim 1, wherein the static mixer is removed from the passage opening after introducing the heat-conducting medium between the at least one battery module and the cooling base.

6. The Method as claimed in claim 1, wherein the static mixer, after removing from the passage opening, is inserted into a second passage opening of a second battery module for introducing the heat-conducting medium between the second battery module and the cooling base.

7. The method as claimed in claim 1, wherein the battery module is fastened to a battery housing providing the cooling base, before the heat-conducting medium is introduced between the battery module and the cooling base.

8. An injection system for introducing a heat conducting medium between a battery module and a cooling base, wherein the injection system comprises the battery module, which is positionable in relation to the cooling base in such a way that a lower side of the battery module faces toward the cooling base and an upper side of the battery module faces away from the cooling base, wherein passage opening extending from the upper side to the lower side of the battery module is arranged in the battery module and the injection system furthermore comprises a static mixer, which is at least partially insertable into the passage opening, and which comprises a filling opening, into which multiple components to be mixed to provide the heat-conducting medium can be filled at a defined filling pressure after it is at least partially inserted into the passage opening, so that the filled components pass through the static mixer and leave the static mixer at the lower side of the battery module through an outlet opening of the static mixer as components mixed by the static mixer to form the heat-conducting medium and can be pressed at least partially between the battery module and the cooling base.

9. The Battery module for an injection system as claimed in claim 8, wherein the battery module comprises the passage opening, into which the static mixer of the injection system is at least partially insertable.

10. The Battery module as claimed in claim 9, wherein the battery module comprises a module housing and a cell stack, which is accommodated in the module housing and comprises multiple individual battery cells, wherein the module housing comprises at least one first side wall, which delimits the cell stack in its longitudinal extension direction (z), and wherein the passage opening, into which the static mixer is at least partially insertable, is arranged in the at least one first side wall.

11. The method as claimed in claim 2, wherein the static mixer is inserted into the passage opening in such a way that the outlet opening providing a lower end of the static mixer is inserted on top into the passage opening and guided through the passage opening at least to the lower side of the battery module, in particular wherein the passage opening comprises a circumferential chamfer or a circumferential collar or a circumferential cone, in particular comprises a circumferential conical collar, and has a tapering cross section in the profile toward the lower side, so that the static mixer can only be guided through the passage opening up to an end position defined by the tapering cross section.

12. The method as claimed in claim 2, wherein the static mixer is inserted into the passage opening in such a way that an upper end of the static mixer, at which the filling opening of the static mixer is located, is at least not inserted completely into the passage opening.

13. The method as claimed in claim 3, wherein the static mixer is inserted into the passage opening in such a way that an upper end of the static mixer, at which the filling opening of the static mixer is located, is at least not inserted completely into the passage opening.

14. The method as claimed in claim 2, wherein the static mixer is removed from the passage opening after introducing the heat-conducting medium between the at least one battery module and the cooling base.

15. The method as claimed in claim 3, wherein the static mixer is removed from the passage opening after introducing the heat-conducting medium between the at least one battery module and the cooling base.

16. The method as claimed in claim 4, wherein the static mixer is removed from the passage opening after introducing the heat-conducting medium between the at least one battery module and the cooling base.

17. The method as claimed in claim 2, wherein the static mixer, after removing from the passage opening, is inserted into a second passage opening of a second battery module for introducing the heat-conducting medium between the second battery module and the cooling base.

18. The method as claimed in claim 3, wherein the static mixer, after removing from the passage opening, is inserted into a second passage opening of a second battery module for introducing the heat-conducting medium between the second battery module and the cooling base.

19. The method as claimed in claim 4, wherein the static mixer, after removing from the passage opening, is inserted into a second passage opening of a second battery module for introducing the heat-conducting medium between the second battery module and the cooling base.

20. The method as claimed in claim 5, wherein the static mixer, after removing from the passage opening, is inserted into a second passage opening of a second battery module for introducing the heat-conducting medium between the second battery module and the cooling base.
